(19) United States
(12) Patent Application Publication
(10) Pub. No.: US 2007/0137061 A1
(43) Pub. Date: Jun. 21, 2007

(54) Freeze dryer shelf assembly

(76) Inventor: Gerald Bogdan, Amherst, NY (US)

Correspondence Address: Bernard Lau;The BOC Group, Inc., Legal Services-IP, 575 Mountain Ave., Murray Hill, NJ, 07974, US

(21) Appl. No.: 11/311,093

(22) Filed: Dec. 19, 2005

(51) Int. Cl. F26B 5/06

(52) U.S. Cl. 34/284; 34/282

(57) ABSTRACT

In a method of assembling a freeze dryer shelf having opposed, parallel first and second plates spaced apart from one another, and a plurality of ribs defining at least one flow channel for conveying a diathermic fluid between the first and second plates, the ribs are first located against the first plate and secured to the first plate. The second plate is then located against the ribs, and the ribs are secured to the second plate by, for each rib, inserting a welding torch between the first and second plates and adjacent the rib, and moving the welding torch along a joint between the rib and the second plate to weld together the rib and the second plate.

### BACKGROUND OF THE INVENTION

1. Field of the Invention

The present invention relates to a freeze dryer shelf and to a method of assembling a freeze dryer shelf.

2. Description of the Related Art

Freeze dryer shelves are located within a freeze drying chamber of a freeze dryer for receiving a plurality of containers or vials containing the product to be freeze dried. The chamber usually includes a number of shelves, each of which can be raised and lowered within the chamber. To load the shelves, the shelves are initially collapsed in the lower portion of the chamber, and the uppermost shelf is first moved into a loading position. After that shelf has been loaded, the mechanism automatically raises the loaded shelf to enable the next shelf to be moved to the loading position. This moving sequence continues until the chamber loading has been completed. To unload the chamber, the loading sequence is reversed, with the lowermost shelf being unloaded first.

The shelves also serve to transfer heat between a diathermic fluid such as alcohol, glycol, or silicone oil, and the products to be freeze-dried. During the freeze drying process, moisture present within the products is frozen. An external refrigeration circuit cools diathermic fluid circulating within the freeze dryer shelves in order to cause heat to be transferred from the products to the diathermic fluid and thereby cause the freezing of the moisture contained within the products. After freezing, the chamber is evacuated to a pressure typically below 1 mbar, and the diathermic fluid is heated by an external heater to cause the ice within the samples to sublimate into water vapour.

Freeze dryer shelves are typically formed by two opposed stainless steel plates having ribs located between the plates in order to form both a space, typically between 10 and 20 mm in height, between the plates and flow channels for the diathermic fluid. The four edges of the plates are capped with solid bars continuously welded to the top and bottom plates.

Various methods are used to assemble such a freeze dryer shelf. In a first known assembly method, the ribs are welded to one of the plates. Holes are then drilled into the opposite plate and this plate is then plug welded to the ribs. The resultant raised weld beads are subsequently ground flush and polished.

One problem associated with this assembly method is that the welds tend to thermally stress the plates in the vicinity of the welding. In order to reduce local deformation of the plates near the welding, very thick plates are used in fabricating the shelves and solid ribs are used in forming the flow channels for the diathermic fluid. Consequently, the shelf possesses a sizable thermal mass or inertia, with the result that a large fraction of the energy requirement of the freeze dryer during the cooling phase of the freeze drying process is wasted in cooling the shelves. Another problem is that the plug welds can be unreliable, and so with time diathermic fluid can leak from the shelf.

In a second known assembly method, the ribs are welded to each of the plates, each rib being a “C”-shaped element. The plates are then mechanically interlocked by sliding the elements together. Again, the shelf possesses a sizable thermal mass, and the welding of the C-shaped elements to the plates increases both the cost of the plate and the manual labour required to assemble the shelf.

A third known method of assembling a freeze dryer shelf is described in U.S. Pat. No. 5,519,946. In this method, a nickel brazing substance is sandwiched between the bottom plate and the ribs, and between the ribs and the top plate.

The sub-assembly is sandwiched between graphite blocks and placed inside a vacuum induction furnace, which is ramped up to the melting point of nickel and the crystallisation temperature of stainless steel. The temperature is stabilised to stress relieve the sub-assembly, and then the furnace is gradually cooled to around 200° C. The sub-assembly is then quenched with inert gas and allowed to cool to room temperature. The solid bars are then welded to the plates to cap the edges of the plates. Due to the brazing technique used to assemble the shelf, the ribs can be provided by hollow rectangular tubes to reduce the thermal mass of the shelf. However, the initial set-up costs are relatively high, particularly if the sizes of the shelves are not to be unduly limited.

### SUMMARY OF THE INVENTION

At least the preferred embodiment of the invention seeks to solve these and other problems.

In a first aspect, the present invention provides a method of assembling a freeze dryer shelf having opposed, parallel first and second plates spaced apart from one another, and a plurality of ribs defining at least one flow channel for conveying a diathermic fluid between the first and second plates, the method comprising the steps of locating the ribs against the first plate, securing the ribs to the first plate, locating the second plate against the ribs, and securing the ribs to the second plate by, for each rib, inserting a welding torch between the first and second plates and adjacent the rib, and moving the welding torch along a joint between the rib and the second plate to weld together the rib and the second plate.

By securing the ribs to the second plate in this manner, a closing weld between the ribs and the second plate can be made without compromising the integrity of the second plate. The welding of the ribs to the second plate can be fully automated, reducing the cost associated with manual methods of welding the ribs to the plate, and enhancing the quality and reproducibility of the welds securing the ribs to the plate. Unlike the second known assembly method, there is no requirement to provide interlocking members to secure the second plate to the first plate, thereby reducing the thermal mass of the shelf, and unlike the third known assembly method there is no requirement for any special vacuum ovens.

The welding torch may comprise a welding head attached to a moveable arm for moving the welding head along the joint, with movement of the arm between the first and second plates being guided by at least one of the ribs adjacent the arm. For example, the arm may be provided with at least one guide member engaging said at least one of the ribs as the arm is moved between the first and second plates. Alternatively, the arm may be mounted on a moveable carriage upon which said at least one guide member is located. The at least one guide member preferably comprises one or more wheels or roller elements. One or more such wheels or roller elements may be provided on each side of the arm, or carriage, for engaging a respective rib as the arm is moved between the first and second plates.

In a preferred embodiment, the welding torch is a gas metal arc welding torch comprising a welding cable attached to the welding head and carried by the carriage for feeding electric current and at least one of welding wire and gas to the welding head. In this embodiment, a supply of electric current and at least one of welding wire and gas are controllably fed to the welding head as the welding head is moved along the joint to weld together the rib and the second plate. The feeding of the supply of electric current and said at least one of welding wire and gas to the welding head may be intermittently interrupted as the welding head is moved along the joint to produce a number of spaced welds between the rib and the second plate.

The welding torch may be angled so that the weld is accurately located along the joint between the rib and the second plate. Alternatively, the welding torch may be oscillated vertically as it is moved along the joint in order to ensure that at least part of the weld is located over the joint. Consequently, any mis-alignment of the welding wire does not cause the weld to be formed over one surface only.

The first and second plates may be clamped together as the welding torch is moved therebetween.

The ribs are preferably secured to the first plate by welding. A plurality of spaced welds are preferably formed at each joint.

A rectangular frame may be subsequently located between and secured to the first and second plates, preferably by welding, to peripherally seal the shelf, the frame having fluid inlet and outlet ports for introducing and discharging diathermic fluid to and from the shelf.

In a second aspect, the present invention provides a freeze dryer shelf having opposed, parallel first and second plates spaced apart from one another, and a plurality of ribs defining at least one flow channel for conveying a diathermic fluid between the first and second plates, the ribs being secured to the first plate by welds located within said at least one flow channel at the joints between the ribs and the first plate, and secured to the second plate by welds located within said at least one flow channel at the joints between the ribs and the second plate.

The ribs preferably comprise rectangular pipes having elongated, opposed flat surfaces. The use of pipes for the ribs enables the diathermic fluid to flow within the ribs, as well as along the sides of the ribs within said at least one flow channel, to produce a uniform heat transfer to a product located on the shelf during use of the shelf. Furthermore, by the use of hollow ribs, the shelf has a elatively low thermal mass, and a relatively low amount of energy is required to selectively cool or heat the shelf.

The ribs preferably extend substantially parallel to each other, and are preferably substantially equidistantly spaced. This can facilitate movement of the welding torch between the plates, as the width of the carriage may be designed to be substantially equal to the spacing of the plates. The ribs are preferably arranged between the first and second plates to define a serpentine flow path for diathermic fluid conveyed between the plates.

The spacing between the first and second plates is preferably between 10 and 20 mm, more preferably between 12 and 16 mm.

Features described above in relation to the first aspect of the invention are equally applicable to the second aspect of the invention, and vice versa.

### BRIEF DESCRIPTION OF THE DRAWINGS

Preferred features of the present invention will now be described with reference to the accompanying drawings, in which:

FIG. 1 is a top plan view of a freeze dryer shelf with one plate broken away;

FIG. 2 is a perspective view of part of the shelf of FIG. 1 to illustrate the welds between a first plate and the ribs of the shelf;

FIG. 3 is a perspective view of part of the shelf of FIG. 1 to illustrate the welds between a second plate and the ribs of the shelf;

FIG. 4 is a schematic side view of a welding torch securing a rib to the first plate of the shelf;

FIG. 5 is a view of one example of a welding torch located between two ribs that is suitable for welding a rib to the second plate;

FIG. 6 is a view of the welding torch of FIG. 5 inserted between two plates separated by two ribs; and

FIG. 7 is a view of another example of a welding torch that is suitable for welding a rib to the second plate.

### DETAILED DESCRIPTION OF PREFERRED EMBODIMENTS

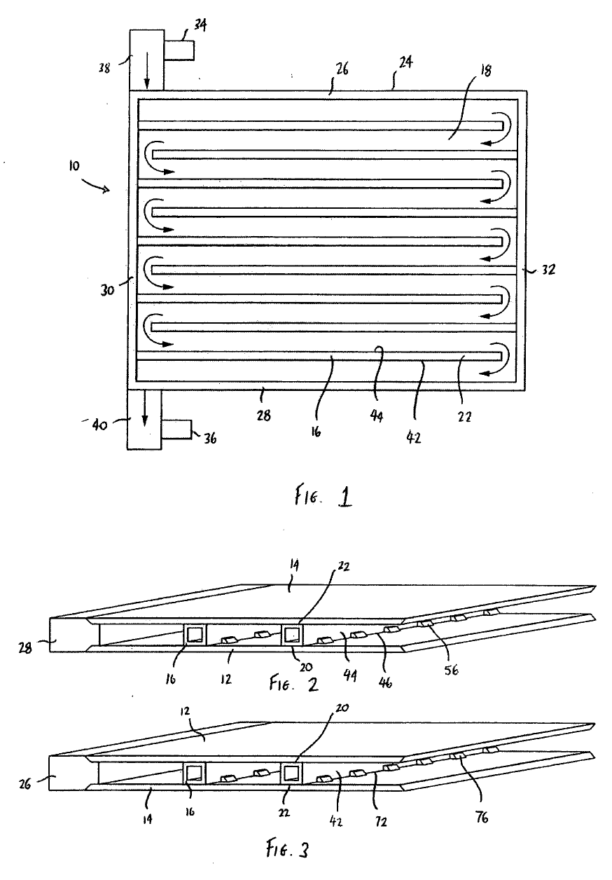

With reference to FIGS. 1 to 3, a freeze dryer shelf 10 comprises a pair of first and second plates 12,14. Both plates are flat, parallel and spaced apart from one another. A plurality of ribs 16 are provided within the space formed between first and second plates 12,14. The ribs 16 are spaced apart to define at least one flow channel 18 for diathermic fluid conveyed between the first and second plates 12, 14. In this regard, the ribs 16 are substantially parallel and staggered relative to one are another in order to produce a serpentine flow path through the shelf 10, and thereby minimize pressure drop. The ribs 16 are preferably hollow rectangular tubes, although they may take any form having elongated flat surfaces 20, 22 in contact with the first and second plates 12,14 respectively.

The shelf 10 is peripherally sealed by a frame 24 comprising bars or rods 26, 28, 30, 32 each having a substantially square or rectangular transverse cross-section. The rods are connected end-to-end, and secured to the first and second plates 12, 14. Diathermic fluid flows into and is discharged from the shelf 10 by fluid inlet and outlet ports formed by inlet and outlet pipes 34, 36 connected to inlet and outlet tab portions 38, 40 provided with internal drillings. Diathermic fluid enters into and is discharged from the flow channels 18 through apertures defined in rods 26, 28 and in communication with each of the internal drillings of tab portions 38, 40. Inlet and outlet pipes 34, 36 are connected to hoses which are, in turn, connected to an external circuit for the diathermic fluid which conventionally includes a pump to circulate the diathermic fluid, a refrigerant circuit for cooling the diathermic fluid during the freezing phase of the freeze drying process, and an electrical heater for heating the diathermic fluid during the sublimation phase of the freeze drying process. Support blocks may be provided on the outer periphery of the shelf 10 for receiving support rods for connecting the shelf 10 to other shelves within a chamber of a freeze dryer.

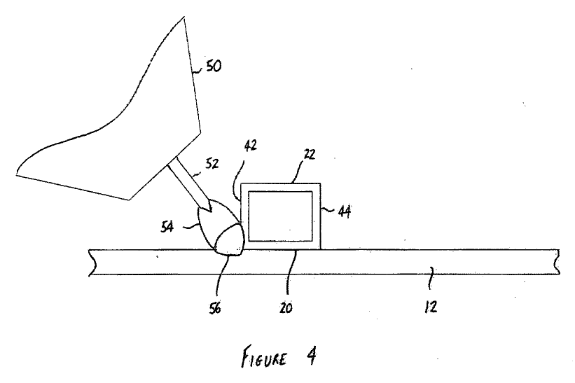

All of the aforementioned components of the freeze dryer shelf 10 are preferably fabricated from stainless steel. In order to assemble the shelf 10, the ribs 16 are initially located on the first plate 12 such that the ribs 16 extend substantially parallel to each other, are preferably substantially equidistantly spaced, and are staggered relative to one another to define the serpentine flow path through the assembled shelf. Referring to FIG. 4, a conventional MIG welding torch 50 is employed to manually weld together the first plate 12 and the ribs 16. Such welding torches and their operation are well known and so will not be described in detail here. The welding torch 50 feeds a consumable electrode 52 to a weld zone 54 located at the joint 46 between the first plate 12 and one of the elongated, opposed side surfaces 42, 44 of a rib 16. An electric arc is struck between the tip of the electrode 52 and the first plate 12 and rib 16 in the vicinity of the weld zone 54. Molten metal is transferred from the electrode 52 to the weld zone 54 through the arc. A shielding gas, typically consisting of argon, optionally with relatively small quantities of oxygen, carbon dioxide and hydrogen added, is supplied from the welding torch around the consumable electrode 52 so as to inhibit oxidation of the weld metal. As illustrated in FIG. 2, a plurality of spaced welds 56 may be formed at each joint 46 between the first plate 12 and the ribs 16 to secure the ribs 16 to the first plate. Alternatively, a continuous weld may be formed at each joint 16.

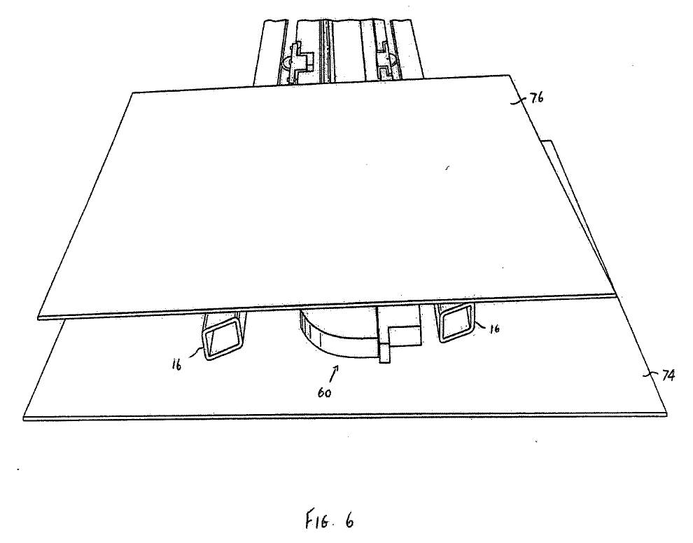

When each of the ribs 16 has been secured to the first plate 12, the second plate 14 is located against the ribs 16 such that the second plate 14 overlies the first plate 12, and is preferably secured in place by clamps or the like so that the second plate 14 is not dislodged as the ribs 16 are secured thereto. To secure a rib 16 to the second plate 14, a welding torch 60 is inserted between the first and second plates 12,14 and adjacent that rib 16. As illustrated in FIG. 5, the welding torch 60 comprises a narrow welding head 62 connected to a welding cable 64. As illustrated in FIG. 6, the welding torch 60 is dimensioned such that the torch 60 can be inserted between two plates 74, 76 separated by ribs 16 and preferably without disturbing the uppermost of the two plates, and so has typically a thickness of between 10 and 20 mm, preferably between 12 and 14 mm.

In this example the welding torch is a MIG welding torch 60. The welding cable 64 contains a centrally disposed, continuous consumable welding wire providing a metal electrode having a tip terminating at the welding head 62, at least one electrical conductor for providing a flow of current from a power source to the welding head 62, and a gas conduit for providing a flow of shielding gas, again typically consisting of argon, optionally with relatively small quantities of oxygen, carbon dioxide and hydrogen added, to the welding head 62.

The welding head 62 is attached to a drive arm 66 mounted on, or integral with, a moveable carriage 68 such that the welding head 62 faces towards the joint 72 between the second plate 14 and the rib 16. The welding cable 64 is located on the carriage 68 adjacent the drive arm 66. A set of wheels or roller elements 70 is located on each side of the carriage 68 for engaging a side surface 42, 44 of a respective rib 16 as the carriage 68 is moved between the first and second plates 12,14 to precisely position the welding head relative to the joint 72 between the second plate 14 and the rib 16 as the welding torch 60 is moved between the first and second plates 12, 14. In this example, the welding head 62 is positioned at an angle on the drive arm 66, or the drive arm 66 is positioned at an angle on the carriage 68, so that the weld formed by the welding torch will be located over the joint 72 between the second plate 14 and the rib 16.

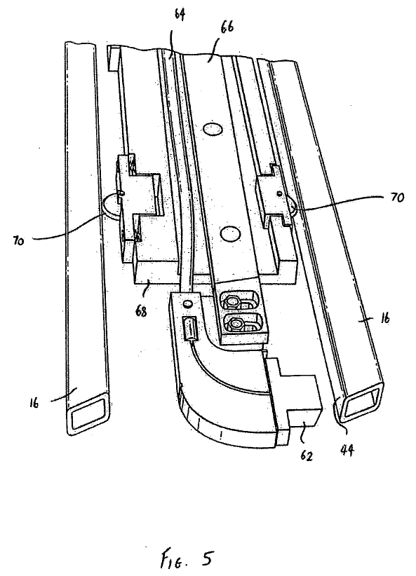

In use, with the welding torch 60 inserted between the first and second plates 12, is 14 and adjacent one end of a rib 16 to be secured to the second plate 14, the drive arm 66 is moved towards the other end of the rib 16 so that the welding head 62 is moved along the joint 72 between the rib 16 and the second plate 14. The drive arm 66 may be moved by pushing or pulling the drive arm 66 or carriage 68, and is preferably moved at a substantially constant speed. As the drive arm 66 is moved between the first and second plates 12, 14, a supply of electric current and at least one of welding wire and shielding gas is controllably fed to the welding head 62 as the welding head 62 is moved along the joint 72 to weld together the rib 16 and the second plate 14. The feeding of the supply of electric current, welding wire and shielding gas to the welding head 62 is preferably intermittently interrupted as the welding head 62 is moved along the joint 72 to produce a number of spaced welds 76 between the rib 16 and the second plate 14, as illustrated in FIG. 3.

Following the completion of the welding of the rib 16 to the second plate 14, the welding torch 60 is re-inserted between the first and second plates 12,14 and adjacent another rib 16 to secure that rib 16 to the second plate 14. The procedure is repeated as required until all of the ribs 16 have been secured to the second plate 14. The bars or rods 26, 28, 30, 32 of the frame 24 are then secured to the first and second plates 12, 14, preferably by a continuous welding technique, to complete the shelf assembly.

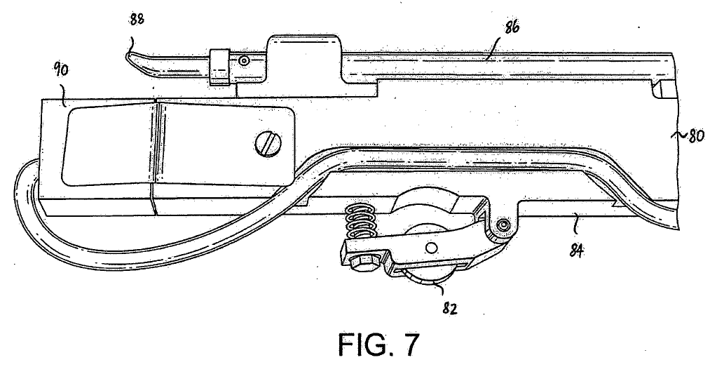

In a second example illustrated in FIG. 7, the drive arm 80 has one or more wheels or roller elements 82 attached to one side 84 of the drive arm 80 for guiding the movement of the drive arm 80 as it moves between the first and second plates 12,14. A metal tube 86 is provided along the other side of the drive arm 80, extending substantially parallel to the drive arm 80. The tube 86 has a curved end 88 proximate the welding head 90.

When the drive arm 80 has been moved between the plates 12, 14 to a position adjacent one end of a rib 16, a motor (not shown) is actuated to cause the tube 86 to rotate. The rotary motion of the motor is transferred into a rotational oscillation of the tube 86 via a linkage. The curved end of the tube 86 engages the first plate 12 and, with further rotation of the tube, causes the welding head 90 to rise to a position at which a weld bead can be formed at the joint between the second plate 14 and the rib. The motor continues to rotate, causing an oscillating motion in the weld head through the rotational oscillation of the tube 86. The oscillating motion ensures the weld is formed between the plate 14 and the rib 16, and that any slight mis-position of the welding wire fed to the welding head 90 does not cause the weld to form only to one surface. This essentially mimics the “walking” of the weld head as performed by a manual welder.

Welding is then initiated, and the drive arm 80 is moved towards the other end of the rib 16 to form an elongate weld bead between the second plate 14 and the rib 16. As in the previous embodiment, the feeding of the electric current, welding wire and shielding gas to the welding head may be intermittently interrupted so that a series of spaced welds are formed between the second plate 14 and the rib 16.

Once the welding has been completed, the motor is actuated in reverse to lower the welding head. The drive arm may then be repositioned between the plates to weld another rib to the second plate.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. A method of assembling a freeze dryer shelf having opposed, parallel first and second plates spaced apart from one another, and a plurality of ribs defining at least one flow channel for conveying a diathermic fluid between the first and second plates, the method comprising the steps of:
locating the ribs against the first plate;
securing the ribs to the first plate;
locating the second plate against the ribs; and
securing the ribs to the second plate by, for each rib, inserting a welding torch between the first and second plates and adjacent the rib, and moving the welding torch along a joint between the rib and the second plate to weld together the rib and the second plate.

2. A method according to claim 1, wherein the welding torch comprises a welding head attached to a moveable arm for moving the welding head along the joint, movement of the arm between the first and second plates being guided by at least one of the ribs adjacent the arm.

3. A method according to claim 2, wherein the arm is provided with at least one guide member engaging said at least one of the ribs as the arm is moved between the first and second plates.

4. A method according to claim 3, wherein the said at least one guide member comprise a wheel or roller element located on a side of the arm for engaging a rib as the arm is moved between the first and second plates.

5. A method according to claim 2, wherein the arm is mounted on a moveable carriage comprising at least one guide member engaging said at least one of the ribs as the arm is moved between the first and second plates.

6. A method according to claim 3, wherein the said at least one guide member comprise a wheel or roller element located on a side of the carriage for engaging a rib as the arm is moved between the first and second plates.

7. A method according to claim 2, wherein the welding torch is a gas metal arc welding torch comprising a welding cable attached to the welding head and carried by the carriage for feeding electric current and at least one of welding wire and gas to the welding head, and wherein the method comprises controllably feeding a supply of electric current and at least one of welding wire and gas to the welding head as the welding head is moved along the joint.

8. A method according to claim 7, wherein the feeding of the supply of electric current and said at least one of welding wire and gas to the welding head is intermittently interrupted as the welding head is moved along the joint to produce a number of spaced welds between the rib and the second plate.

9. A method according to claim 1, wherein the welding torch is oscillated vertically as it is moved along the joint.

10. A method according to claim 1, wherein a rectangular frame is subsequently located between and secured to the first and second plates to peripherally seal the shelf, the frame having fluid inlet and outlet ports for introducing and discharging diathermic fluid to and from the shelf.

11. A freeze dryer shelf having opposed, parallel first and second plates spaced apart from one another, and a plurality of ribs defining at least one flow channel for conveying a diathermic fluid between the first and second plates, the ribs being secured to the first plate by welds located within said at least one flow channel at the joints between the ribs and the first plate, and secured to the second plate by welds located within said at least one flow channel at the joints between the ribs and the second plate.

12. A shelf according to claim 11, wherein the ribs comprise rectangular pipes having elongated, opposed flat surfaces.

13. A shelf according to claim 11, comprising a rectangular frame located between and secured to the first and second plates to peripherally seal the shelf, the frame having fluid inlet and outlet ports for introducing and discharging diathermic fluid to and from the shelf.
